(19) United States
(12) Patent Application Publication
(10) Pub. No.: US 2024/0377632 A1
(43) Pub. Date: Nov. 14, 2024

(54) Projector-Based HUD for a Vehicle Having An Increase In Contrast and Efficiency Via a Circular Polarizer

(71) Applicant: Bayerische Motoren Werke Aktiengesellschaft, Muenchen (DE)

(72) Inventors: Michael Arthur Janzer, Unterschleissheim (DE); Jasper Stern, Muenchen (DE)

(21) Appl. No.: 18/656,698

(22) Filed: May 7, 2024

(30) Foreign Application Priority Data
May 8, 2023 (DE) 10 2023 111 970.2

(51) Int. Cl. G02B 27/01; G02B 5/30

(52) U.S. Cl. CPC G02B 27/0101; G02B 5/3025; G02B 2027/0118

(57) ABSTRACT

A projection unit for a field-of-view display device, which is configured to show a virtual image via reflection on a partially transparent reflection plate arranged in the field of view of a user, such as a vehicle window, includes a projector-based image generator having a projector and a projection screen illuminated thereby, wherein the projector is configured to generate a real image on the projection screen and the projection screen is configured to project the resulting light beam bundle in a predetermined shape and direction onto the reflection plate; and a contrast element arranged in relation to the projection screen and configured such that it is only passed by the light beam bundle originating from the projection screen and this is largely without attenuation, and it is passed twice by the ambient light incident on the projection screen and reflected thereon and eliminates it.

### CROSS REFERENCE TO RELATED APPLICATION

This application claims priority under 35 U.S.C. § 119 from German Patent Application No. DE 10 2023 111 970.2, filed May 8, 2023, the entire disclosure of which is herein expressly incorporated by reference.

### BACKGROUND AND SUMMARY

The invention relates to field-of-view display devices, which are usable in motor vehicles or other land, air, or water vehicles and are also known under the name head-up display (HUD). Such devices are used to generate a virtual image shown in the field of view of a user via reflection on an at least partially transparent reflection plate, such as a front, rear, or side window of the vehicle or a combiner plate separately provided for this purpose, in the field of view of the user. The invention is also directed to a projection unit which is designed to output a light beam bundle suitable for this purpose, and to a vehicle equipped therewith.

Speed specifications and other useful navigation, warning, and vehicle operation notifications or also entertainment content in the form of a virtual image, for example, are overlaid on the real surroundings image observed by the driver and/or another occupant in front of the vehicle using a head-up display in a motor vehicle. Among other things, simplified head-up displays for generating a panoramic virtual representation are known, which are implemented by an image generator which is positioned in a window base region of the windshield so that the real image generated by the image generator is reflected directly on the windshield and thus reaches the observer (driver and/or front passenger).

Previous approaches for technologically implementing such HUDs generally use liquid crystal display screens (LCD) having a matrix backlight. However, this technology reaches its limits, for example with regard to the heat management and the power consumption, when the virtual image is to be displayed in the transparent area of the windshield which is above the so-called black print area of the windshield, which is provided with a dark or black coating. In comparison to a virtual image which is displayed completely in the black print area of the windshield, this results in a tenfold multiplication of the required image brightness, so that a required visibility of the HUD image is ensured even in sunny ambient conditions. To achieve such high image brightnesses, comparatively costly micro-LED displays could be used. A less costly alternative would be the use of a projector-based system, in which a projection screen (also called movie screen or screen) is positioned at the point of the display surface on which a real image is generated by way of a projector.

The properties of the projection screen are decisive for both the energy efficiency and the image quality. To achieve the highest possible energy efficiency, the projection screen has to have the highest possible “gain” (yield), i.e., it has to guide the incident projector light in its entirety as much as possible into the eyebox. For good image quality, in particular high contrast even in high ambient brightnesses, the projection screens are generally provided with a dark absorbent coating, which does absorb the ambient light, but also significantly attenuates the projector light (typical reduction >>50%). This works against the desired high efficiency of the overall system. However, a good contrast value is indispensable for good image quality, which results here in a conflict between image quality and energy efficiency, which cannot be resolved by the prior art.

It is the object of the present invention to specify an alternative and/or improved projection unit for a field-of-view display device, which can be used in particular in a vehicle and which can be suitable in particular for a large-area and/or panoramic virtual image representation via reflection on a windshield. This projection unit and field-of-view display device can enable an improvement over known devices, for example, with regard to their energy efficiency, costs, contrast, visibility in high ambient brightness, image quality, and/or other aspects.

This object is achieved by a projection unit and by a field-of-view display device containing this projection unit and a vehicle equipped therewith according to the claimed invention. All refining features and effects mentioned in the claims and in the following description for the projection unit also apply with respect to the field-of-view display device and the vehicle, and vice versa.

According to a first aspect, a projection unit is provided for a field-of-view display device, which can be designed in particular for use in a vehicle. The vehicle can be a motor vehicle, but also any other land, air, or water vehicle. The field-of-view display device can be designed, for example, as a head-up display (HUD).

The projection unit is designed, in operation of the field-of-view display device, to output a light beam bundle and to project it in suitable shape and direction onto a reflection plate, which is arranged in the field of view of a user, is reflective on the user side, and is at least partially transparent on the rear side, from which it is reflected to his eyes (or his eyebox) and thus a virtual image floating beyond the reflection plate is displayed to him. The eyebox of the field-of-view display device is understood as usual as a spatial area from which the virtual image is visible unrestrictedly for the user. The reflection plate can in particular be formed as a subsection of a windshield or another vehicle window or a combiner plate separately provided for this purpose. In operation of the field-of-view display device, it is arranged outside the projection unit, so that the projection unit can also be produced and sold separately from the reflection plate.

The projection unit comprises a projector-based image generator having a projector, which is designed to generate a light beam bundle having desired display content, and a projection screen (also called movie screen or screen) illuminated thereby. The projector is designed to generate a real image on the projection screen. The projection screen is designed to project the light beam bundle resulting therefrom in predetermined shape and direction onto the reflection plate in order to generate a virtual image having desired representation properties for the user beyond the reflection plate.

Furthermore, the projection unit comprises opposite the projection screen, i.e., in the beam path of the light beam bundle originating from the projection screen, a contrast element which can extend in particular over the entire beam cross-section required for virtual image generation. The contrast element is arranged and designed so that it is only passed once by the light beam bundle and also lets it through substantially unattenuated, i.e., at least by half and ideally nearly completely. In other words, the contrast element is arranged so that it is not passed by the light beam bundle on its path from the projector to the projection screen. At the same time, the contrast element is arranged and designed so that it is passed a total of twice by all of the ambient light incident on the projection screen and reflected thereon and eliminates it in this case.

Using this structure of the projector-based projection unit, the greatest possible energy efficiency is thus achievable with undiminished contrast even with high ambient brightness values. It is therefore also suitable, inter alia, for virtual image representation in the transparent area of the windshield mentioned at the outset, which is above its black print area, which extends along the windshield base and is typically printed black or dark.

According to one embodiment, the projection screen is designed for reflecting the light beam bundle originating from the projector in the direction of the reflection plate. In other words, the projection screen is illuminated in this embodiment by the projector in reflection. The contrast element is arranged opposite the projection screen in the beam path of the entire light beam bundle reflected thereby, but outside the beam path of the light beam bundle propagating from the projector to the projection screen, so that the contrast element is not passed by the latter. For this purpose, the contrast element can be arranged at a suitable spatial distance and/or alignment with respect to the projector-based image generator, so that it does not protrude into the intermediate space between the projector and the projection screen (a particularly compact arrangement example thereof is shown in FIGS. 1a-2).

One concept in this projection unit is to resolve the conflict mentioned at the outset between the image quality and the energy efficiency of the projector-based image generator in that the function of the “reduction of the brightness of the ambient light on the projection screen” is detached from the projection screen and moved into a separate element (the contrast element) spatially isolated from the projection screen. It is thus possible to differentiate between the ambient light and the projector light. It can be ensured in this case via a corresponding preparation of the projector light that the light originating from the projection screen in the direction of the reflection plate, which transports the real image, passes the contrast element nearly undisturbed.

Alternatively to the above embodiment, however, the projection screen can also be illuminated by the projector in transmission. In this case, the contrast element can in principle also be arranged/applied directly to a surface of the projection screen facing away from the projector and facing toward the reflection plate, in order to fulfill its functionality presented herein.

In one specific embodiment, the contrast element can be designed, for example, as a circular polarizer, which is composed of a quarter-wave retarder facing toward the projection screen and a linear polarizer facing away from the projection screen. The projection screen is designed here so that the polarization of the ambient light incident on the projection screen, which is circularly polarized after passage of the circular polarizer, is retained upon the reflection thereon. After the second passage of the quarter-wave retarder, the ambient light again has a linear polarization, however with a polarization direction which is rotated by 90° in relation to the transmission direction of the linear polarizer. The reflected ambient light is therefore blocked or absorbed by the linear polarizer, in other words eliminated. The projector-based image generator can in particular be designed here so that the light beam bundle originating from the projection screen has a circular polarization, which becomes a linear polarization let through by the linear polarizer after passage of the quarter-wave retarder and can therefore pass this linear polarizer unattenuated.

If the projection screen is illuminated by the projector in reflection in this embodiment, the projector can be designed for the above purpose for generating the light beam bundle having such a circular polarization which is converted by the quarter-wave retarder into the linear polarization let through by the linear polarizer. The projection screen is also designed here for a polarization-retaining reflection of the light beam bundle.

However, alternatively to the circular polarization mentioned in the above two paragraphs, the projector light can also, for example, have a polarization which is not manipulated by the quarter-wave retarder. In this case, the projector light is linearly polarized parallel to the fast or slow axis of the quarter-wave retarder and is therefore also let through by 50% by the linear polarizer.

In order that the projection screen reflects light in a polarization-retaining manner, it can be designed as metallic, for example, in particular by a metallic coating of its upper or intermediate surface provided for image generation.

In one refinement of the above embodiment, in which the projection screen reflects the light beam bundle generated by the projector, the projection screen has a mirror surface for this purpose, which is composed of a large number of facets to form a facet grid having a sawtooth profile. Each facet has a mirror segment for a directed guiding of the light beam bundle, for example, into a center of the eyebox predetermined for user eyes. The energy efficiency of the field-of-view display device having the projector-based image generator can furthermore be significantly increased by such directed eyebox illumination. The respective mirror segment can in particular be made planar. Alternatively thereto, a curved, for example concave, design can be expedient.

The sawtooth profile can arise here, inter alia, in that the mirror segments of the facets can have different angles depending on the position on the facet grid or mirror array. Therefore, they do not always adjoin one another continuously, so that height offsets of adjacent facets can be equalized by transition surfaces oriented nearly perpendicular to their mirror segments, for example, due to which a sawtooth profile results. The surfaces of the individual facets or of their mirror segments can in particular be below a size resolvable using the human eye, so that the facet grid is not recognizable to the user in the virtual image. The linear dimensions thereof can in particular be greater than the largest wavelength of the projector light used and can be, for example, in the micrometer range. To avoid interfering diffraction effects such as color fringes or interference, etc., the surfaces of the individual facets/mirror segments can moreover have sizes and/or shapes varying from one another.

According to a further aspect, a field-of-view display device is provided which can be designed in particular for use (i.e., installation) in a vehicle. The field-of-view display device also comprises, in addition to the projection unit presented herein, a reflection plate which is arranged in the beam path of the light beam bundle output by the projection unit, is reflective on the user side, and is at least partially transparent to ambient light incident on the rear side, which can be designed in particular as a subsection of a vehicle window or as a separately provided combiner plate. The reflection plate is arranged in the field of view of the user and designed such that it reflects the light beam bundle to his eyebox, by which the display content can be displayed to him in the form of a virtual image beyond the reflection plate and also is displayed in operation of the field-of-view display device.

According to one embodiment, the reflection plate is arranged directly opposite the contrast element and the projection screen located behind it and/or below it, with the exception of possible covers of the projection unit (for example in the form of a cover plate letting through the light beam bundle), which do not have a beamforming, beam deflecting, or imaging optical effect on the light beam bundle. In other words, in this specific embodiment the field-of-view display device does not comprise further optical elements such as deflection mirrors or concave mirrors or lenses, etc. in the beam path of the light beam bundle between the contrast element and the reflection plate. Any coatings of the projection screen, the contrast element, or the reflection plate having optical functionality are still possible, however. A projection unit which is particularly compact in the height direction may be implemented in particular using this embodiment, which is therefore also well suited in particular for a large-area virtual representation such as a panoramic representation.

According to a further aspect, the above-mentioned vehicle is provided. The spatial orientation terms used herein such as “above”, “below”, “laterally”, “horizontally”, “vertically”, etc. relate in this case to the typical vehicle-fixed Cartesian coordinate system having longitudinal, transverse, and vertical axes of the vehicle perpendicular to one another. The vehicle has, for example, at least one vehicle window, such as a windshield having a dashboard extending below it, and a passenger compartment partially delimited thereby. It is equipped with the above field-of-view display device, the projection unit of which can be installed, for example, directly in or below an upper side of the dashboard, so that the light beam bundle is projected from the projection unit on the windshield or a combiner plate arranged directly in front of it in the field of view of the driver and/or another occupant, which is used as the above-mentioned reflection plate of the field-of-view display device. The field-of-view display device can also be integrated at any other suitable installation location in the vehicle, however, wherein other vehicle windows or combiner plates arranged in the passenger compartment at other points can also be used as reflection plates.

In particular, the windshield can be delimited in the vehicle transverse direction to the left and right in each case by a A-pillar of the vehicle and the projection unit and its projection screen can be arranged in or below the upper side of the dashboard such that the windshield is used as the reflection plate at least with a large part of its extension in the vehicle transverse direction. In particular a panoramic virtual representation for the driver and/or front passenger is thus implementable.

The above aspects of the invention and its embodiments and specific designs will be explained in more detail hereinafter on the basis of an example shown in the appended drawings. The drawings are to be understood as solely schematic illustrations of the fundamental optical design principle, i.e. not to scale.

### BRIEF DESCRIPTION OF THE DRAWINGS

FIG. 1a shows a detail of a vehicle having a field-of-view display device according to an exemplary embodiment of the invention in a vertical longitudinal section, with a schematic representation of the beam path of the projector light.

FIG. 1b shows an enlarged detail view of the field-of-view display device of FIG. 1a, which shows the optical structure of a contrast element in its projection unit.

FIG. 2 shows a vertical longitudinal sectional view of the projection unit of the field-of-view display device of FIG. 1a with a schematic representation of the beam path of the ambient light.

### DETAILED DESCRIPTION OF THE DRAWINGS

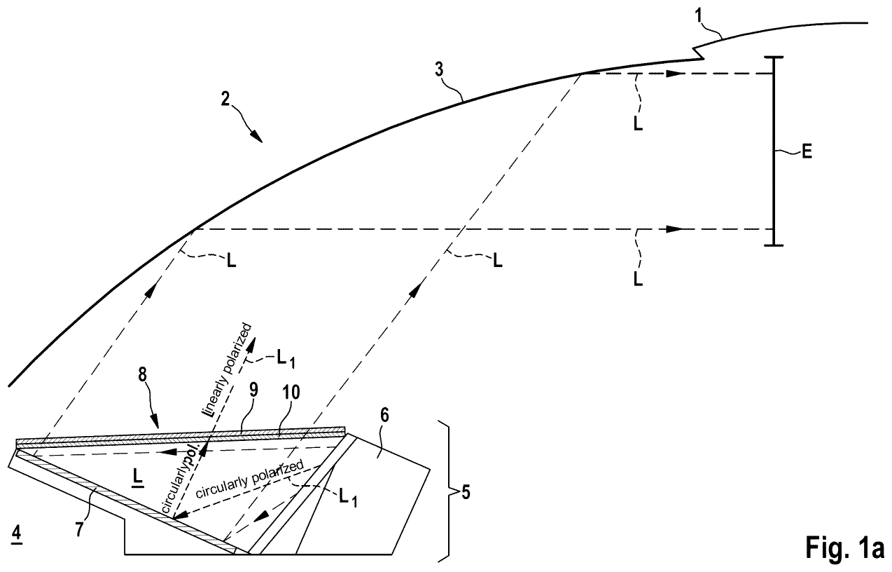

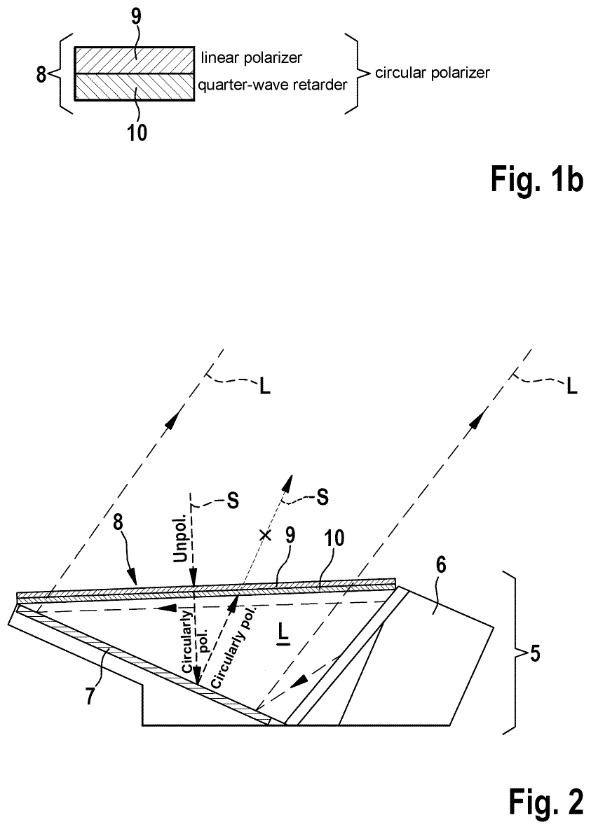

All of the different embodiments, alternatives, and specific design features of the projection unit, of the field-of-view display device and of the vehicle mentioned above in the description and the following claims according to the above aspects of the invention can be implemented in the examples shown in FIGS. 1a to 2, in particular also alternatively or additionally to the features shown therein. They are therefore not all repeated once again hereinafter. This also applies accordingly to the concept definitions and effects already indicated above with respect to individual features shown in FIGS. 1a-2.

FIG. 1a shows a greatly simplified vertical longitudinal sectional view of a detail of a vehicle 1 having a field-of-view display device 2 according to an exemplary embodiment of the invention. The spatial orientation terms used hereinafter such as “horizontal”, “vertical”, “above”, “below”, “underneath”, etc. relate to the typical vehicle-fixed Cartesian coordinate system having longitudinal, transverse, and vertical directions of the vehicle 1 perpendicular to one another. The vehicle 1 is a motor vehicle in this example, which is indicated in FIG. 1a only by its windshield 3, which is used as the above-mentioned reflection plate of the field-of-view display device 2. A projection unit 5 of the field-of-view display device 2 is arranged underneath it in a dashboard 4 (not shown in more detail).

The field-of-view display device 2 is designed to generate a virtual image (not shown) in the field of view of at least one user, who is indicated in FIG. 1a only by a spatial area (eyebox) E intended for his eyes in the passenger compartment of the vehicle 1. The at least one user can be, for example, a driver and/or front passenger of the vehicle 1. The field-of-view display device 2 can be designed in particular for a panoramic virtual representation in that the windshield 3 is used with nearly its entire extension in the vehicle transverse direction as the reflection plate of the field-of-view display device 2. Solely by way of example, it is a head-up display (HUD).

The projection unit 5 contains a projector-based image generator. This comprises a projector 6, which is designed to generate a light beam bundle L having desired display content, and a projection screen 7 (also called movie screen or screen) illuminated thereby. The light beam bundle L is indicated by its edge beams, which delimit its beam cross section required for the virtual image generation.

In this example, the projector 6 is designed to generate a real image on the projection screen 7 in reflection and therefore illuminates it diagonally from above. The projection screen 7 is designed here to project the resulting, i.e., reflected light beam bundle L in predetermined shape and direction onto the windshield 3, in order to display to the user a virtual image having desired representation properties beyond the windshield 3.

Furthermore, the projection unit 5 comprises, in the beam path of the light beam bundle L originating/reflected from the projection screen 7, a contrast element 8 which extends over the entire beam cross section of the light beam bundle L required for virtual image generation. The contrast element 8 is arranged and designed here so that it is only passed by the light beam bundle L once and also lets it through substantially unattenuated. In other words, the contrast element 8 is arranged so that it is not passed by the light beam bundle L on its path from the projector 6 to the projection screen 7. This is achieved in FIG. 1a by an arrangement of the contrast element 8 obliquely in relation to the projection screen 7 above the upper edge beam of the light beam bundle L propagating from the projector 6 to the projection screen 7.

As schematically illustrated in FIG. 2 on the basis of the example of a sunbeam, the contrast element 8 is arranged and designed at the same time so that it is passed a total of twice by all of the ambient light S incident on the projection screen 7 and reflected thereon and eliminates it in this case. For this purpose, FIG. 2 shows the projection unit 5 of FIG. 1a in the same longitudinal sectional view as in FIG. 1a.

A possible embodiment for this functionality will be described hereinafter on the basis of FIGS. 1a, 1b, and 2.

As additionally illustrated in FIG. 1b in an enlarged detail of FIG. 1a, the contrast element 8 is implemented in this example as a combination of a linear polarizer 9 and a quarter-wave retarder 10. The alignment of these two elements in relation to one another is selected here so that they act together as a circular polarizer. It is important here that the linear polarizer 9 faces away from the projection screen 7 and the quarter-wave retarder 10 faces toward the projection screen 7. Ambient light S which is incident from the outside through the contrast element 8 on the projection screen 7 is thus circularly polarized. This circularly polarized light is reflected by the projection screen 7 and has to pass through the contrast element 8 again. The quarter-wave retarder 10 acts on the light here so that overall a retardation of λ/4+λ/4=λ/2 results and therefore linearly polarized ambient light S leaves the quarter-wave retarder 10. However, the polarization direction of this light is rotated by 90° in relation to the transmission direction of the linear polarizer 9 and is thus absorbed in the linear polarizer 9. The condition for this is that the projection screen 7 reflects the light in a polarization-retaining manner. This can be achieved, for example, by a metallic coating. The goal of not having ambient light S pass from the projection screen 7 into the eye of the user and thus achieving a high contrast value is therefore achieved.

In contrast to the ambient light S, which has to pass through the contrast element 8 twice, the light beam bundle L only passes through the contrast element 8 once, namely only after its reflection on the projection screen 7. This projector light, the beam path of which is additionally illustrated in FIG. 1a on the basis of a single projector light beam L1, can pass the contrast element 8 nearly undisturbed (except for negligible classic Fresnel losses due to reflection at the air-material interface), if it is circularly polarized so that it has a linear polarization after passing through the quarter-wave retarder 10, which corresponds to the transmission direction of the linear polarizer 9. It is again a condition for this purpose that the projection screen 7 reflects the light from the projector 6 in a polarization-retaining manner.

Using embodiments of the invention presented herein, a projector-based HUD system may be constructed, which does not have to make a compromise between contrast and energy efficiency, but can meet both requirements optimally. In particular, a large-area and/or panoramic virtual representation via reflection in a vehicle window is thus possible. This therefore represents a well implementable and overall better alternative to LCD-based or μLED-based field-of-view display devices mentioned at the outset.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 vehicle
2 field-of-view display device
3 windshield
4 dashboard
5 projection unit
6 projector
7 projection screen
8 contrast element
9 linear polarizer
10 quarter-wave retarder
L light beam bundle, also called projector light
L1 individual projector light beam of the light beam bundle
E eyebox
S ambient light

What is claimed is:

1. A projection unit for a field-of-view display device, which is configured to show a virtual image via reflection on a partially transparent reflection plate arranged in a field of view of a user, the projection unit comprising:
a projector-based image generator having a projector for generating a light beam bundle having desired display content and a projection screen illuminated by the projector, wherein the projector is configured to generate a real image on the projection screen and the projection screen is configured to project the light beam bundle resulting therefrom in a predetermined shape and direction onto the reflection plate; and
a contrast element arranged in relation to the projection screen and configured such that the contrast element is only passed by the light beam bundle originating from the projection screen largely without attenuation, and the contrast element is passed a total of twice by all of the ambient light incident on the projection screen and reflected thereon and eliminates the ambient light.

2. The projection unit according to claim 1, wherein the reflection plate is a vehicle window.

3. The projection unit according to claim 1, wherein
the projection screen is configured to reflect the light beam bundle in a direction of the reflection plate; and
the contrast element is arranged opposite the projection screen in a beam path of the entire light beam bundle reflected by the projection screen, and outside a beam path of the light beam bundle propagating from the projector to the projection screen, so that the contrast element is not passed by the light beam bundle propagating from the projector to the projection screen.

4. The projection unit according to claim 1, wherein
the projector is arranged and configured for rear illumination of the projection screen;
the projection screen is arranged and configured for transmitting the light beam bundle in a direction of the reflection plate; and
the contrast element is arranged in a beam path of the entire light beam bundle transmitted by the projection screen.

5. The projection unit according to claim 4, wherein the contrast element is arranged directly on the projection screen.

6. The projection unit according to claim 1, wherein
the contrast element is configured as a circular polarizer, which is composed of a quarter-wave retarder facing toward the projection screen and a linear polarizer facing away from the projection screen; and
the projection screen is configured so that a circular polarization of the ambient light incident on the projection screen after passing the contrast element is retained upon the reflection on the projection screen.

7. The projection unit according to claim 6, wherein
the image generator is configured such that the light beam bundle originating from the projection screen is circularly polarized so that after passing the quarter-wave retarder the light beam bundle has a linear polarization let through by the linear polarizer.

8. The projection unit according to claim 2, wherein
the contrast element is configured as a circular polarizer, which is composed of a quarter-wave retarder facing toward the projection screen and a linear polarizer facing away from the projection screen;
the projection screen is configured so that a circular polarization of the ambient light incident on the projection screen after passing the contrast element is retained upon the reflection on the projection screen;
the image generator is configured such that the light beam bundle originating from the projection screen is circularly polarized so that after passing the quarter-wave retarder the light beam bundle has a linear polarization let through by the linear polarizer;
the projector is configured to generate the light beam bundle having the circular polarization which is converted by the quarter-wave retarder into the linear polarization let through by the linear polarizer; and
the projection screen is configured for a polarization-retaining reflection of the light beam bundle.

9. The projection unit according to claim 6, wherein
the projection screen is metallic for the polarization-retaining reflection.

10. The projection unit according to claim 9, wherein the projection screen has a metallic coating.

11. The projection unit according to claim 2, wherein
the contrast element is configured as a circular polarizer, which is composed of a quarter-wave retarder facing toward the projection screen and a linear polarizer facing away from the projection screen;
the projection screen is configured so that a circular polarization of the ambient light incident on the projection screen after passing the contrast element is retained upon the reflection on the projection screen;
the image generator is configured such that the light beam bundle originating from the projection screen is circularly polarized so that after passing the quarter-wave retarder the light beam bundle has a linear polarization let through by the linear polarizer;
the projection screen has a mirror surface for reflecting the light beam bundle in the direction of the reflection plate, which is composed of a large number of facets to form a facet grid having a sawtooth profile; and
each facet has a mirror segment for directed guiding of the light beam bundle into an eyebox predetermined for user eyes.

12. The projection unit according to claim 11, wherein the mirror segment is configured to guide the light beam bundle into a center of the user eyes.

13. A field-of-view display comprising:
the projection unit according to claim 1; and
the reflection plate which is arranged in the beam path of the light beam bundle output by the projection unit, is reflecting on a user side, and is at least partially transparent for ambient light incident on the rear side,
wherein the reflection plate is arranged in the field of view of the user and is configured such that the reflection plate reflects the light beam bundle to an eyebox predetermined for user eyes, due to which the display content is displaceable to the user in a form of a virtual image beyond the reflection plate.

14. The projection unit according to claim 13, wherein
the reflection plate is arranged directly opposite the contrast element and the projection screen located behind and/or below the contrast element, except for covers of the projection unit, which do not have a beamforming, beam deflecting, or imaging optical effect on the light beam bundle.

15. A vehicle comprising:
a vehicle window and a passenger compartment partially delimited by the vehicle window; and
the field-of-view display device according to claim 13, the reflection plate of which is configured as part of the vehicle window or as a combiner plate arranged in the passenger compartment.

16. The projection unit according to claim 15, wherein the vehicle window is a windshield.

17. The vehicle according to claim 16 having longitudinal, transverse, and vertical directions perpendicular to one another of a vehicle-fixed Cartesian coordinate system, wherein
the windshield is delimited in the transverse direction in each case on the left and right by an A-pillar of the vehicle;
the vehicle has a dashboard arranged below the windshield; and
the projection unit of the field-of-view display device and the projection screen are arranged in or below an upper side of the dashboard such that the windshield is used at least with a large part of its extension in the vehicle transverse direction as the reflection plate of the field-of-view display device.
